(19) United States
(12) Patent Application Publication
(10) Pub. No.: US 2025/0381704 A1
(43) Pub. Date: Dec. 18, 2025

(54) ELEVATED PRESSURE HYBRID WOOD MODIFICATION

(71) Applicant: ALPHA HOLDING BRANDE APS, Grindsted (DK)

(72) Inventor: Johann Peter KLAAS, Martofte (DK)

(21) Appl. No.: 18/878,962

(22) PCT Filed: Jun. 29, 2023
(86) PCT No.: PCT/DK2023/050173

§ 371 Date: Dec. 26, 2024

(30) Foreign Application Priority Data
Jun. 29, 2022 (DK) PA 2022 70347

(51) Int. Cl. B27K 3/15; B27K 3/02; B27K 3/08; C08L 97/02

(52) U.S. Cl. CPC B27K 3/156; B27K 3/0271; B27K 3/0278; B27K 3/08; C08L 97/02; C08L 2312/00

(57) ABSTRACT

A novel and inventive method of Wood Modification is provided, combining two singular modification strategies for accessible OH group reduction into one, simultaneous hybrid process, by taking advantage of a high-pressure modification process.

### CROSS-REFERENCE TO RELATED APPLICATIONS

This application is a national stage of PCT Application No. PCT/DK2023/050173, having a filing date of Jun. 29, 2023, which is based on DK Application No. PA 2022 70347, having a filing date of Jun. 29, 2022, the entire contents both of which are hereby incorporated by reference.

### FIELD OF TECHNOLOGY

The following relates to a novel and inventive method of Wood Modification, combining two singular modification strategies for accessible OH group reduction into one, simultaneous hybrid process, by taking advantage of a high-pressure modification process.

### BACKGROUND

Commercially, the most important property enhancement of wood is improved resistance to biological attack. This has traditionally been achieved by treatment with biocides. However, the use of biocides is increasingly perceived as being problematic by institutions and markets, and this is why Wood Modification aims at achieving improved resistance to biological attack by non-biocidal modes of action.

Biocidal treatment is a cost-effective way of achieving improved resistance to biological attack. The drawbacks of biocidal treatment of wood are the problematic disposal or recycling of biocidal treated wood, which is costly due to the environmental impact if it is not handled and disposed of properly. In comparison, Wood Modification today is a less cost-effective process but has a much lower environmental impact in use, for recycling and disposal. However, the higher production costs experienced today significantly reduces its commercial potential as a substitute for biocide treatment.

Hill, C. (2006): “Wood Modification-Chemical, Thermal and Other Processes”, Wiley & Sons Ltd., West Sussex. defines Wood Modification on pages 20-21 as to involve the action of a chemical, biological or physical reagent upon the material, resulting in a desired property enhancement during the service life of the modified wood. The modified wood itself should be nontoxic under service conditions, and furthermore, there should be no release of any toxic substances during service, or at end of life, following disposal or recycling of the modified wood. If the modification is intended for improved resistance to biological attack, then the mode of action should be non-biocidal”.

Hill (see also Jones & Sandberg 2020) identifies different classes of Wood Modification, including “Cross-Linking”, “Bulking” and “Thermal”, into two broad approaches of passive and active modifications.

The common factor for the above-mentioned Wood Modification techniques is the goal of reducing accessible OH (hydroxyl) groups within the wood. Therefore, existing arts can all be classified by belonging to one of the classes identified by Hill (2006), using singular strategies for OH group reduction, such as “cross-linking” or “thermal”. Some examples exist where these singular strategies have been combined into sequential process, e.g., by first performing thermal modification followed by cross-linking modification. From an industrial perspective these are very costly and of limited commercial interest.

The most commercially utilized Wood Modification processes are thermally based processes and chemical processes. Some of the more commonly used processes include, but are not limited to: Thermal modification, Acetylation, Furfurylation, DMDHEU based processes and impregnation with PF (Phenolic Formaldehyde).

Known processes for Wood Modification are for example disclosed in WO 2011/144608 A1 that discloses a furfurylation process, in US 2008/0223360 A1 that discloses a Wood Modification process using cross-linkable Nitrogen compounds and in EP2485800 that discloses a method of impregnation with a crosslinking impregnation reagent with a low molecular weight oligomer with OH groups followed by a drying step and then crosslinking the impregnation reagent by applying elevated temperature and pressure.

WO2009095687 A1 discloses a chemical and thermally based process for acetylation of wood comprising submerging the wood in an acetylation fluid under pressure, and subsequently heating the wood under controlled conditions to initiate two distinct exothermic reactions.

The process disclosed in WO2009095687 A1 includes well-known steps of impregnation by submerging wood in an acetylation fluid at a temperature of 10° C. to 120° and increasing the pressure in the vessel to 2 to 20 bar for a period of 10 minutes to 300 minutes any subsequently removing the excess acetylation fluid from the vessel. After the traditional steps of impregnating the wood, an inert fluid is introduced into the vessel and is circulated and heated until the internal temperature of the wood begins to show an exotherm reaction and maintaining the internal temperature of the wood below 170° C., reheating the inert fluid to initiate a second exothermic reaction, while still maintaining the internal temperature of the wood below 170° C.

The known conventional art discloses the utilization of an impregnation solution comprising both suitable impregnation reagent and an additional catalyst, wherein the catalyst utilized is typically an acidic catalyst. The application of an acidic catalyst during the impregnation process presents major drawbacks in the form of additional cost and intricacy because it requires expensive acid resistant process equipment and processes for handing the acid impregnation solution.

In addition, the processes disclosed in conventional art all include a drying step for limiting the water content in the wood. This drying step adds complexity to the process and create additional costs to the end-product.

Furthermore, conventional art represent singular approaches to accessible OH group reduction. This is an important drawback, because singular approaches only remove a part of all accessible OH groups within the wood. There is a direct correlation between removal of accessible OH groups and desired wood performance improvements in important properties such as decay resistance and dimensional stability. Therefore, partial removal of accessible OH groups will lead to less-than-optimal wood performance improvements. The maximum removal OH group removal rate for known conventional arts reported in scientific literature, is 60%.

Embodiments of the present invention primarily focus on, but are not limited to, combination or simultaneous application of chemical processes for providing highly beneficial, cost-effective processes for treatment of wood.

### SUMMARY

An aspect relates to reducing the industrial process costs of Wood Modification and improve the effectiveness, versatility, and quality of the process, in order to increase further its commercial potential for substituting biocide treated wood.

An aspect relates to a method of generally modifying cellulose-based material, in particular wood and engineered wood.

In embodiments, it is an aspect to achieve a simple Wood Modification process that facilitates removal or strongly reduces accessible OH groups in the modified wood. Desired improvement of wood products, such as durability and dimensional stability, is a direct function of degree of removal of accessible OH groups.

An aspect relates to overcoming one or more of the before mentioned shortcomings of the conventional art, by obliterating the use of catalysts during the impregnation step and the application of a drying step during the process, while producing a higher quality modified wood.

### DETAILED DESCRIPTION

One aspect of embodiments of the present invention is to provide a method of modifying wood comprising the steps of:
a) Selecting and placing the wood in a treatment chamber;
b) Preparing a pH neutral aqueous impregnant solution comprising at least one reagent suitable for polymerization and/or chemical reaction with the wood;
c) Impregnating the wood with the pH neutral aqueous impregnant solution;
d) Increasing the pressure in the treatment chamber, so that the pressure is always above the boiling point of water for any temperature in the treatment chamber, and
e) increasing the temperature in the treatment chamber, so that a combined processes of polymerization/chemical reaction of the impregnant and thermal hydrolysis of wood hemicelluloses is facilitated;
   wherein the wood does not receive any physical and/or chemical treatment between step c) and step d).

Another aspect of embodiments of the present invention is to provide a method of modifying wood comprising the steps of:
a) Selecting and placing the wood in a treatment chamber;
b) Preparing a pH neutral aqueous impregnant solution comprising at least one reagent suitable for polymerization and/or chemical reaction with the wood;
c) Impregnating the wood with the pH neutral aqueous impregnant solution;
d) Increasing the pressure in the treatment chamber, so that the pressure is always above the boiling point of water for any temperature in the treatment chamber, and
e) Increasing the temperature in the treatment chamber, so that a combined processes of polymerization/chemical reaction of the impregnant and thermal hydrolysis of wood hemicelluloses is facilitated, and wherein embodiments of the method of modifying wood further comprises the following steps:
f) When the treatment chamber has reached the desired temperature of step e), maintaining both the applied temperature and pressure for a holding phase; and
g) When the holding phase is completed, decreasing both temperature and pressure within the treatment chamber down to ambient temperature and pressure,
   wherein the wood does not receive any physical and/or chemical treatment between step c) and step d).

The two steps of
c) increasing the pressure in the treatment chamber, so that the pressure is always above the boiling point of water for any temperature in the treatment chamber, and
d) increasing the temperature in the treatment chamber, so that a combined processes of polymerization/chemical reaction of the impregnant and thermal hydrolysis of wood hemicelluloses is facilitated;
   may be performed in an iterative or simultaneous process to maintain the pressure in the treatment chamber above water's boiling point when the temperature is increased.

In embodiments, the method of modifying wood provided by embodiments of the present invention provides a process step where the pressure in the treatment chamber has to be kept above the boiling point of water, while the boiling point of water is dependent on the pressure. It is therefore apparent that any increase in applied pressure will depend on the applied temperature and a skilled person would know how to adjust both temperature and pressure accordingly.

Within the present application, when referring to the simultaneous or iterative steps or employment of step c) of increasing the pressure; and step d) of increasing the temperature, it is understood, that for ensuring that the pressure always stays above the boiling point of water for any temperature in the treatment chamber, any pressure elevation will have to be initiated first, as to always stay one step ahead of temperature elevation and that the process of increasing both the pressure and the temperature applied, can be achieved by one or more iterative or repetitive steps, performed more or less simultaneously.

Consequently, within the present application, when referring to step g) decreasing the applied pressure and temperature, it is understood, that for ensuring that the pressure always stays above the boiling point of water, the reduction of temperature has to be initiated first, and the process of decreasing both the pressure and the temperature applied, can be achieved by one or more iterative or repetitive steps, performed more or less simultaneously.

One aspect of embodiments of the present invention is to provide a method for modifying wood, wherein the impregnation step c) utilizes the pH neutral aqueous impregnant solution comprising at least one reagent suitable for polymerization and/or chemical reaction with the wood, prepared in step b) in a liquid phase. This aspect of embodiments of the method provided by embodiments of the invention will herein be termed a liquid phase embodiment.

A liquid phase embodiment of the present invention provides a method of modifying wood, wherein embodiments of the method comprises the following steps:
a) Selecting and placing the wood in a treatment chamber;
b) Preparing a pH neutral aqueous impregnant solution comprising at least one reagent suitable for polymerization and/or chemical reaction with the wood;
c) Impregnating the wood with the pH neutral aqueous impregnant solution in a liquid phase, utilizing a standard vacuum/pressure impregnation process, e.g. Lowry or Bethell, to the required penetration and uptake;
d) Increasing the pressure in the treatment chamber, so that the pressure is always above the boiling point of water for any temperature in the treatment chamber, and
e) increasing the temperature in the treatment chamber, so that a combined processes of polymerization/chemical reaction of the impregnant and hydrolysis of wood hemicelluloses is facilitated,
   wherein the wood does not receive any additional physical and/or chemical treatment between the impregnation of step c) and the application of increased pressure in step d).

In another aspect of embodiments of the present invention a liquid phase embodiment of the present invention provides a method of modifying wood, embodiments of the method further comprising the following steps:
f) When the treatment chamber has reached the desired temperature of step e), maintaining both the applied temperature and pressure for a holding phase; and
g) When the holding phase is completed, decrease both temperature and pressure within the treatment chamber down to ambient temperature and pressure,
   wherein the wood does not receive any additional physical and/or chemical treatment between the impregnation of step c) and the application of increased pressure in step d).

Another aspect of embodiments of the present invention is to provide a method for modifying wood, wherein the impregnation step c) utilizes the pH neutral aqueous impregnant solution comprising at least one reagent suitable for polymerization and/or chemical reaction with the wood, prepared in step b) in a vapor phase. This aspect of the method provided by embodiments of the invention will herein be termed a vapor phase embodiment.

The vapor phase embodiment of the present invention provides a method of modifying wood, wherein embodiments of the method comprise the following steps:
a) Selecting and placing the wood in a treatment chamber;
b) Preparing a pH neutral aqueous impregnant solution comprising at least one reagent suitable for polymerization and/or chemical reaction with the wood;
c) Impregnating the wood with the pH neutral aqueous impregnant solution in a vapor phase, wherein the impregnation process comprising the following steps:
   Heating the treatment chamber, the wood and the pH neutral aqueous impregnant solution prepared in step b) to a suitable temperature;
   Pulling a vacuum in the treatment chamber to vaporize the pH neutral aqueous impregnant solution prepared in step b) into vapor phase;
   Circulating inside the treatment chamber the vaporized pH neutral aqueous impregnant solutioning prepared in step b), thereby impregnating the wood with the pH neutral aqueous impregnant solution prepared in step b),
d) Increasing the pressure in the treatment chamber, so that the pressure is always above the boiling point of water for any temperature in the treatment chamber, and
e) increasing the temperature in the treatment chamber, so that a combined processes of polymerization/chemical reaction of the impregnant and thermal hydrolysis of wood hemicelluloses is facilitated,
   wherein the wood does not receive any additional physical and/or chemical treatment between the impregnation of step c) and the application of increased pressure in step d).

In another aspect of embodiments of the present invention a vapor phase embodiment of the present invention provides a method of modifying wood, embodiments of the method further comprising the following steps:
f) When the treatment chamber has reached the desired temperature of step e), maintaining both the applied temperature and pressure for a holding phase; and
g) When the holding phase is completed, decreasing both temperature and pressure within the treatment chamber down to ambient temperature and pressure,
   wherein the wood does not receive any additional physical and/or chemical treatment between the impregnation of step c) and the application of increased pressure in step d).

Another aspect of embodiments of the present invention is to provide a method for modifying wood wherein the wood is treated in two different chambers, a separate impregnating chamber, suitable for the impregnation method applied, is utilized for the impregnation of step c) and a separate treatment chamber, suitable for applying the increased pressure of step d) and the increased temperature of step e) is utilized for step d) and e). An embodiment of the present invention provides a method of modifying wood, comprising the additional step cc) of relocating the impregnated wood from the impregnating chamber to a treatment chamber, and wherein step cc) is to be performed after the impregnation of step c) and before application of increased pressure of step d) and wherein the wood does not receive any additional physical and/or chemical treatment during step cc).

The step of relocating the impregnated wood is to be performed after impregnating the wood and before performing the step of increasing the pressure. Again, as embodiments of the method for modifying wood provided by embodiments of the present invention is performed in one simultaneous hybrid process, the additional step of relocating the impregnated wood from one chamber to another chamber does not include any further physical and/or chemical treatment, such as increased temperature for a drying phase or any chemical treatment.

Within this application, when referring to a physical or chemical treatment of the wood, it is understood that by that is meant any treatment that changes the physical or chemical composition of the wood in question. This includes but is not limited to changes in moisture (for example drying), temperature and/or pressure or application of any kind of chemical solution or compound.

In one aspect of embodiments of the present invention, a method of modifying wood is provided, wherein the temperature of the treatment chamber is increased in step e) to at least 120° C. but no higher than 200° C., this temperature is what is referred to within this application as a desired temperature. In the aspects of embodiments of the present invention wherein the method of modifying wood comprises step f) and g), is the temperature maintained during the holding phase of step f) In another aspect of embodiments of the present invention the temperature is increased in step e) to be in the range of 120-200 degree ° C. or in the range of 120-180 degree C., and when applicable can be referred to as the desired temperature and maintained during the holding phase of step f). In yet another aspect of embodiments of the present invention the temperature is increased in step e) to be in the range of 130-160 degree C., or between 130-200° C., such as between 130-180° C., or between 120-160° C. or between 130-170° C., and when applicable can be referred to as the desired temperature and maintained during the holding phase of step f). In one aspect of embodiments of the present invention the temperature is increased in step e) to be around 120 degree C., or around 130 degree C., such as around 140 degree C., or around 150 degree C., such as around 160 degree C., or around 170 degree C. or around 180 degree C., and when applicable can be referred to as the desired temperature and maintained during the holding phase of step f).

In one aspect of embodiments of the present invention, a method of modifying wood is provided, wherein the desired temperature achieved in step e) is maintained through the holding phase of step f), and wherein the holding phase of step f) is duration is between 30 minutes to 12 hours, such as between 1 and 12 hours, such as between 5 and 10 hours.

In one aspect of embodiments of the present invention, a method of modifying wood is provided, wherein the pressure in the treatment chamber is elevated in step d) to above 2 bar, such as above 5 bar, such as above 10 bar, such as above 15 bar or above 18 bar. In another aspect of embodiments of the present invention, a method of modifying wood is provided, wherein the pressure in the treatment chamber is elevated in step d) to be in the range of 2-20 bar, such as in the in the range of 5-10 bar, or in the range of 5-15 bar, such as in the range of 7-12 bar, or in the range of 7-15 bar, such as in the range of 5-12 bar, or in the range of 7-18 bar, such as in the range of 10-15 bar, in the range of 10-20 bar, in the range of 15-20 bar, in the range of 10-18 bar, in the range of 15-18 bar, in the range of 18-20 or in the range of 12-15 bar. In yet another aspect of embodiments of the present invention, a method of modifying wood is provided, wherein the pressure in the treatment chamber is increased in step d) to be above 2 bar, such as above 5 bar, or above 7 bar, such as above 10 bar, such as above 15 bar or above 12 bar.

Embodiments of the present invention provide a method for modifying wood, wherein the aqueous pH neutral impregnant solution does not comprise any catalytic compounds, such as acidic catalysts. In one aspect of embodiments of the present invention, the aqueous pH neutral impregnant solution prepared in step b) of the method of Wood Modification provided by embodiments of the present invention, has a pH between 5 and 9, such as with a pH between 6 and 7, or with a pH between 6.5 and 7.5, such as pH around 7. In another aspect of embodiments of the present invention, the aqueous pH neutral impregnant solution prepared in step b) of the method of Wood Modification provided by embodiments of the present invention, contains only a reagent suitable for polymerization and/or chemical reaction with the wood diluted with water. In one aspect of embodiments of the present invention, the aqueous pH neutral impregnant solution prepared in step b) of the method of Wood Modification provided by embodiments of the present invention contains a reagent suitable for polymerization and/or chemical reaction with the wood, diluted in water, in the range from 2%-99% volume/volume, such as between 5%-99% v/v, or anywhere from 2% v/v and up to the specific reagents full saturation in water, when prepared at atmospheric pressure and room temperature.

In one aspect of embodiments of the present invention, the aqueous pH neutral impregnant solution prepared in step b) of the method of Wood Modification provided by embodiments of the present invention contains a mixture of two or more reagents suitable for polymerization and/or chemical reaction with the wood, diluted in water.

In one aspect of embodiments of the present invention, the method of Wood Modification comprises in step b) the preparation of an aqueous pH neutral impregnate solution by diluting in water one or more of the following reagents suitable for polymerization and/or chemical reaction with the wood selected from the group of DMDHEU, Sorbitol, Glycerol, Furfuryl Alcohol and Xylitol.

In one aspect of embodiments of the present invention, the method of Wood Modification comprises in step b) the preparation of an aqueous pH neutral impregnate solution by diluting in water one or more of the following reagents suitable for polymerization and/or chemical reaction with the wood is selected from the group of resin treatments such as PF, MF, MMF and UF resins, Glycerol and Polyglycerol, NMA, Silicon containing compounds, cell wall impregnation with monomers such as MMA, cell wall impregnation with polymers such as HEMA, Sorbitol, other noncyclic anhydrides than acetic anhydride and cyclic anhydrides.

For any practical purposes, embodiments of the present invention apply to both classes Passive and Active of Wood Modification, and the terms “Chemical Modification”, “Impregnation Modification”, “Reagent”, “agent” and “Impregnant” can be used interchangeably to cover both classes of modification processes covered by embodiments of the present invention.

In this application, wood is used as a collective term for any species of wood including solid soft woods, solid hardwoods, wood veneers and any kind of engineered wood. Furthermore, in this application, the terms “hybrid” and “combined” are used interchangeably when referring to the simultaneous application of processes (a) and (b) of Formula 1 (or b1, b2 . . . depending on the reagent utilized) in the Wood Modification method provided by embodiments of the present invention.

A further aspect of embodiments of the invention is to provide a modified wood treated according to one or more of the above disclosed embodiments of the methods for modifying wood.

A further aspect of embodiments of the invention is to provide a method for Wood Modification, by utilization of the one or more of the above disclosed embodiments of the methods for modifying wood.

A further aspect of embodiments of the invention is to provide a method of modifying pre-impregnated wood, by utilizing one or more of the above disclosed embodiments of the methods for modifying wood omitting the step of impregnating the wood.

In embodiments, the method for modifying wood provided by embodiments of the present invention is performed in one, simultaneous hybrid process, and does not involve step with additional physical and/or chemical treatment, such as a drying step, between the impregnation step and the polymerization step, with elevated pressure and/or temperature.

Formally, embodiments of the invention can be generalized by the following expression of Formula 1:

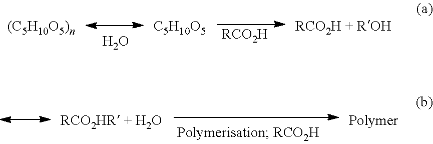

Where (a) represents thermal hydrolysis modification of wood cell hemicelluloses and (b) cross-linking, reaction with wood polymers, lumen filling or cell wall filling, as described by Hill's (2006) overview in his standard textbook.

The fundamental concept of embodiments of the invention is to perform a chemical reaction/polymerization modification process step at elevated pressure, as opposed to atmospheric pressure in existing processes. This facilitates a second, simultaneous process of thermal hydrolysis modification, which improves desired wood properties beyond those only obtained by chemical reaction/polymerization modes of modification, in a novel simultaneous combined modification process, further creating a synergetic effect. In doing so, embodiments of the invention both increases the effectiveness, versatility and quality of industrial Wood Modification techniques, as well as significantly reducing their costs.

As known in the art, different modification techniques represent different strategies for reducing accessible OH groups in the wood cell wall. Not all accessible OH groups can be removed by a single strategy, so that using a single modification strategy will only remove part of the accessible OH groups. For example, Thermal hydrolysis targets the breakdown of cell wall hemi celluloses, which contain a high amount of OH groups. However, OH groups are also present in the celluloses and lignin components of cell wall structures, not efficiently targeted by thermal hydrolytic modification; these may be more effectively targeted by other modification strategies, such as bulking and chemical types of modification. The combination of two modification techniques of thermal hydrolysis and chemical/bulking into one hybrid process, overcomes the limited OH group removal efficiency of singular techniques to achieve significantly higher overall OH group removal efficiency. Empirical testing of the method provided by embodiments of the present invention, demonstrates an increase in OH group removal efficiency of 33% from 60% to 80% (see examples below).

Existing modification Processes perform drying and chemical reaction/polymerisation at atmospheric pressure, or at a vacuum, without any (significant or intended) hybrid modification effect.

In existing chemical modification processes, wood is impregnated with a chemical Reagent (Hill 2006, p. 22) or Impregnant (Hill 2006, p. 23) (e.g., Furfuryl Alcohol, Acetic Anhydride, DMDHEU, Sorbitol or PF resin). In later process step, the impregnated wood is heated to temperatures typically in the range of 70-150° C., depending on the particular process. This causes initial drying of the wood and subsequently the Impregnant to react with the wood cell wall or polymerise in the cell wall, reducing wood cell OH accessibility. This reduction improves durability and reduces swelling, two desired performance characteristics of Modified wood.

Performing a heated polymerisation/chemical reaction process under elevated pressure, as opposed to atmospheric pressure, causes important physical and chemical differences in the modification process. Of particular interest for embodiments of the present invention are the following differences:

### 1. In Situ Catalytic Effect on Chemical Modification:

The majority of chemical Modification processes are catalysed by acid. Therefore, many of the existing processes require an acid in the impregnation fluid, adding complexity to process and equipment.

Heating of moist wood, containing water, to between 12° and 200° C., increasingly causes hydrolysis of wood cell components, primarily hemicelluloses. Residuals from hydrolysis are organic acids, primarily Acetic acid. This in situ emerging acid can then substitute acid in the impregnation fluid as a catalyst, making the fluid pH neutral instead of acidic. This minimizes equipment and process complexity, saving Capital and Operating Costs.

In existing processes, using low pH acidic solutions requires stainless steel and special acid-resistant components, driving up capital costs significantly. With embodiments of the present invention, normal grade steel and standard components can be used, reducing capital costs accordingly. Further, using an acidic impregnation solution cause added operational costs from purchasing and safe handling of the acid itself, which can be saved by using a pure aqueous pH neutral impregnation solution, made possible by embodiments of the present invention.

The in situ catalytic effect is significantly increased by and dependent on elevated pressure: The acids produced by thermal hydrolysis have a boiling point close to that of water. When heating wood at atmospheric pressure, the acids produced by thermal modification will quickly vaporize and leave the wood, reducing the in-situ catalytic effect. At elevated pressure, boiling points of the liquids in the wood are also elevated, causing the acid to remain in its liquid phase and consequently maximizing its cell wall In Situ catalytic effect. As a secondary, important effect, the In Situ catalytic effect kicks in at significantly lower heating temperatures when compared to atmospheric pressure conditions.

### 2. Synergetic Effect of Combining Hybrid Thermal Hydrolysis and Chemical Reaction:

Hydroxyl accessibility is a central theme in Wood Modification technology. As Hill notes, the OH groups associated with the cell wall polymeric constituents are very important in determining many of the properties of Wood. The OH groups are responsible for absorption of moisture, leading to dimensional instability and permitting biological attack of the material. On a molecular level, the cell wall OH groups represent the most important component influencing the performance of wood (Hill, 2006, P. 28).

As discussed in more detail below, the mode of action for improving durability performance and dimensional stability is to reduce the Hydroxyl Accessibility by chemical reaction between the Impregnant, such as Furfuryl Alcohol or DMDHEU, and cell wall OH groups.

However, this mode of action is not completely efficient, so that for different reasons only a partial reduction of accessible OH groups is obtained (see Hill 2006 for further discussions).

Thermal hydrolysis also reduces Hydroxyl Accessibility, by breaking down primarily Hemicelluloses—which contain accessible OH groups-into its residual components such as Acetic Acid and Furans. The primary location of accessible OH groups is in the Hemicelluloses, and therefore removal of hemicelluloses by Hydrolysis is particularly effective in reducing overall wood cell Hydroxyl Accessibility.

In this way, the thermal hydrolyses process removes additional accessible OH groups, not reacting with the Impregnant. It represents an additional and complementary modification effect, leading to overall improved modification. This, in turn, leads to improved wood performance, e.g. improved durability performance and improved dimensional stability, compared to existing Chemical Modification processes at atmospheric pressure. Acosta et al. (2022) report in a recent paper how combining, in a two-step sequential process, thermal modification and furfurylation, the combined process exhibited superior product performance characteristics, such as durability, when compared to the isolated processes.

Hydrolysis is strongly catalysed by Acetic Acid, and for the same reasons as mentioned in (1) above, elevated pressure leads to a maximized catalytic effect. The strong catalytic effect maximizes breakdown and removal of Hemicelluloses containing accessible OH groups. The hybrid Hydrolysis and chemical reaction effect is thus dependent on, or caused by, elevated pressure process conditions.

### 3. Significantly Reduced Process Time:

The application of elevated pressure makes redundant drying of the wood before polymerisation/reaction, necessary in most existing processes. The drying process in an industrial context is known to be lengthy, complicated and costly.

The drying process in existing modification processes step is necessary because the water uptake in the wood resulting from the impregnation step significantly increases the moisture content of the wood. This moisture content too high for the intended use of the final product and has to be lowered. This may be performed prior to the polymerisation/chemical reaction of the monomer/reactant with which the wood was impregnated in an aqueous solution.

The polymerization/chemical reaction requires elevated temperature. If the temperature is too high before drying, the high moisture content will lead to severe quality problems. On the other hand, when drying is performed at lower temperatures, there is a risk that the monomer/reactant will evaporate out of the wood together with water. This causes insufficient volumes of monomer/reactant inside the wood necessary for the required performance of the wood end product.

When the polymerization/reaction process according to embodiments of the present invention is performed at elevated pressure, keeping water below its boiling point, eliminates the risks for the quality problems related to high moisture content, and therefore a drying process step can be omitted. This reduces process lead time and complexity to be reduced significantly (drying process steps typically take at least 48 hours, in many cases much longer). It is well known that reduction of lead times in production is a very important means of minimizing capital and operating costs.

### 4. Improved Product Quality:

When water and other liquids in the wood cells are heated towards and beyond the boiling point, they will vaporize and cause elevated pressure in the wood cells. This causes cracking and related quality problems, extensively known in traditional wood drying processes. These problems in existing industrial processes can be significantly reduced by elevated pressure process conditions, so that pressure is always above boiling point during polymerisation/curing at elevated temperature.

Elaborating on the definitions, classifications and process descriptions presented above, Hill distinguishes between two different modes of action, which he refers to as Active and Passive, respectively.

“Chemical Modification of wood is defined as the reaction of a chemical Reagent with the wood polymeric constituents, resulting in the formation of a covalent bond between the reagent and the wood substrate” (Hill 2006, p. 22). Hill terms this class as “Active” modification, and categorizes processes such as Acetylation, in this category.

“Impregnation modification of wood is defined as any method that results in the filling of the wood substance with an inert material (Impregnant) in order to bring about a desired performance change” (Hill 2006, p. 23). Hill terms this class as “Passive” and categorizes processes such as Furfurylation, DMDHEU, Sorbitol and PF, in this category.
(a) Embodiments of hybrid Wood Modification processes under elevated pressure utilizing different reagent suitable for polymerization and/or chemical reaction with the wood

In the following examples, different embodiments of the present invention are disclosed, where the reagent suitable for polymerization and/or chemical reaction with the wood utilized are Furfuryl Alcohol and DMDHEU.

However, the fundamental process of embodiments of the present invention is independent from the specific Impregnant being used and will apply to all the Impregnant relevant for chemical Modification and Impregnation Modification, as they were defined above. Other examples of Impregnants include but are not limited to Resin treatments such as PF, MF, MMF and UF resins, Glycerol and Polyglycerol, NMA, Silicon containing compounds, cell wall impregnation with monomers such as MMA, cell wall impregnation with polymers such as HEMA, Sorbitol, other noncyclic anhydrides than acetic anhydride, cyclic anhydrides, as well as many other suitable compounds.

Some of these different reagents are marketed commercially under brand names such as “Kenony”, “Accoya”, “Belmadur”, “Archroma”, “Nobelwood”, “Organowood”, “Impreg”, “Compreg”, “Hartholz”, “Indurite”, “Lignia”, “A-Cell”, “Titan Wood”, “Visor Wood”, as well as others.

### Hybrid Thermal Hydrolysis and Furfurylation Modification

A major benefit of using Furfuryl Alcohol is that it is derived from renewable resources. According to Jones & Sandberg, the polymerization of Furfuryl Alcohol in wood is a complex process, and the question whether furfurylation is a distinctive chemical process remains unanswered. Furfuryl Alcohol reacts with itself forming a polymeric structure, and possibly with lignin in the cell walls. Furfuryl Alcohol condenses with itself forming water and a furan condensed product (2020 p. 9). Furfurylated wood has commercially been marketed under brand names such as Kebony, Foreco Dalfsen (“nobelwood”) and VisorWood.

Furfurylation processes are illustrated below in Formula 2.; note how the expression below substitutes the more general expression (b) in the general expression of the Hybrid modification presented above in Formula 1:

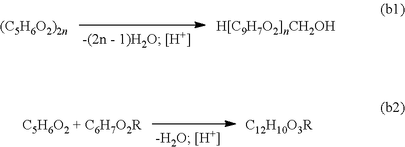

Formula 2. (after Sandberg & Jones 2020, P. 9 FIG. 5): Reactions during the furfurylation of wood: (b1) self-condensation of Furfuryl Alcohol, forming methylene bridge, and (b2) condensation of Furfuryl Alcohol to phenolic compounds via methylene bridging.

In one aspect of embodiments of the present invention, a method of a liquid phase Furfurylation Wood Modification is provided, wherein the liquid phase Furfurylation Wood Modification comprises the following steps:
a) Selecting the wood to be modified and placing the wood in a suitable impregnation and/or treatment chamber, such as a high pressure/high temperature autoclave;
b) Preparing an impregnation solution comprising Furfuryl Alcohol, by mixing Furfuryl Alcohol in water, creating a pH neutral aqueous impregnation solution. The aqueous impregnation solution may contain from 5% to 99% v/v Furfuryl Alcohol, for example between 20% to 80% Furfuryl Alcohol, depending on the wood species and the intended end use of the product;
c) Impregnating the wood to be modified with the pH neutral aqueous Furfuryl Alcohol impregnation solution, utilizing a standard vacuum/pressure impregnation process, e.g. Lowry or Bethell, to the required penetration and uptake. If the impregnation chamber is a separate chamber from the treatment chamber to be utilized in step d), the process includes the additional step of:
   cc) Removing the wood from the impregnation chamber and placing it in a separate treatment chamber, suitable for further modification of the wood, such as a high pressure/high temperature autoclave;
d) Initiating and facilitating a hybrid thermal hydrolysis and polymerisation/reaction process without prior drying of the impregnated wood by increasing the pressure within the treatment chamber, e.g. by applying inert gas, e.g. Nitrogen, in such a way that pressure is always above the boiling point of water, when the treatment chamber is heated above water's ambivalent boiling point;
e) Increasing the temperature of the treatment chamber, thereby facilitating, by means of increased temperature, the hybrid thermal hydrolysis and polymerisation/reaction processes, until the wood to be modified reaches the desired temperature for thermal hydrolysis as well as polymerisation/curing process (“holding phase temperature”). The holding phase temperature shall be in the range of 120 to 200° C., depending on the wood species, ratio of heartwood to sapwood, wood dimensions as well as the desired end use of the product. The process of increasing the temperature and pressure of the autoclave or treatment chamber, can be achieved in a simultaneous or iterative process comprising one or more iterative or repetitive steps, performed more or less simultaneously for ensuring that the pressure always stays above the boiling point of water;
f) When the treatment chamber has reached the desired temperature, maintaining both the applied temperature and pressure for a holding phase, the holding phase being in the range of 30 minutes to 12 hours, again depending on wood species, ratio of heartwood to sapwood, dimensions as well as the desired end use of the product; and
g) When the holding phase is completed, decrease both temperature and pressure within the treatment chamber down to ambient temperature and pressure, after which the process is completed, and the wood can be further processed or put to its intended use.

In another aspect of embodiments of the present invention, a method of a vapor phase Furfurylation Wood Modification is provided, wherein the vapor phase Furfurylation Wood Modification comprises the following steps:
a) Selecting the wood to be modified and placing the wood in a suitable treatment chamber, such as a high pressure/high temperature autoclave;
b) Preparing an impregnation solution comprising Furfuryl Alcohol, by mixing Furfuryl Alcohol in water, creating a pH neutral aqueous impregnation solution, as the aqueous impregnation solution does not comprise any acidic catalysts. The aqueous impregnation solution may contain from 5% to 99% Furfuryl Alcohol, for example between 20% to 80% Furfuryl Alcohol, depending on the wood species and the intended end use of the product;
c) Impregnating the wood with the pH neutral aqueous Furfuryl Alcohol impregnant solution in a vapor phase, wherein the impregnation process comprises the following steps:
   Heating the treatment chamber, the wood and the pH neutral aqueous Furfuryl Alcohol impregnant solution prepared in step b) to a suitable temperature;
   Pulling a vacuum in the treatment chamber to vaporize the pH neutral aqueous Furfuryl Alcohol impregnant solution into vapor phase;
   Circulating inside the treatment chamber the vaporized pH neutral aqueous Furfuryl Alcohol impregnant solution thereby impregnating the wood with the pH neutral aqueous impregnant solution prepared in step b),
d) Initiating a hybrid thermal hydrolysis and polymerisation/reaction process by further elevating the pressure in the treatment chamber, in such a way that the pressure is always above the boiling point of water, when the treatment chamber is heated above water's ambivalent boiling point;
e) Heating the treatment chamber, wood and PH neutral impregnant solution comprising Furfuryl Alcohol, thereby facilitating, by means of increased temperature, the combined processes of chemical reaction of Vapor Phase Furfuryl Alcohol, as well as thermal hydrolysis of wood hemicelluloses, until the wood to be modified reaches the desired temperature for polymerisation/curing process (“holding phase temperature”). The holding phase temperature shall be in the range of 120 to 200° C., depending on the wood species, ratio of heartwood to sapwood, wood dimensions as well as the desired end use of the product. The process of increasing the temperature and pressure of the treatment chamber, can be achieved in a simultaneous or iterative process comprising one or more iterative or repetitive steps, performed more or less simultaneously for ensuring that the pressure always stays above the boiling point of water;
f) When the treatment chamber has reached the desired temperature, maintaining both the applied temperature and pressure for a holding phase, the holding phase being in the range of 30 minutes to 12 hours, again depending on wood species, ratio of heartwood to sapwood, dimensions as well as the desired end use of the product; and
g) When the holding phase is completed, decrease both temperature and pressure within the treatment chamber down to ambient temperature and pressure, after which the process is completed, and the wood can be further processed or put to its intended use.

It should be noted that a person skilled in the art would be capable of calibrating relevant process parameters (e.g. solution strength, temperature, pressure, holding time etc.) calibrated in such a way that the level of thermal hydrolysis, necessary for the required catalytic effect from the in-situ formation of carboxylic acids by hydrolysis on the polymerisation/chemical reaction of Furfuryl Alcohol, is obtained, and be capable of such calibration for receiving the desired level of thermal hydrolysis. Furthermore, a person skilled in the art would be aware that all relevant process parameters (e.g. solution strength, temperature, pressure, holding time etc.) should be calibrated in such a way that leaching after EN 84 or similar international quality standard is below 5%. When this is obtained, it can be assumed that correct volumes of Furfuryl Alcohol are taken up in the wood, and that all the Furfuryl Alcohol is polymerized/reacted with the wood cell wall. When leaching is above 5%, it may be assumed that this is caused by too high uptakes of Furfuryl Alcohol and/or incomplete polymerisation/chemical reaction, and process parameters should be calibrated accordingly.

### Hybrid Thermal Hydrolysis and DMDHEU Modification

DMDHEU (Dimethyloldihydroxyethyleneurea) was developed for and widely used by the textile industry. Reported applications of DMDHEU for mood modification purposes began in the 1960's and continues to receive attention in present day research.

According to Xie et al (2008), different reactions can occur when wood is impregnated with DMDHEU and heated, the two principial ones being the formation of crosslinks between the wood cell (hydroxyl groups) and DMDHEU, and further condensation with NH groups to form methylene bonds. These two processes are formalized further below in Formula 3. Different catalysts have been reported for the modification of wood with DMDHEU, including organic acids, (Xie et al., 1998).

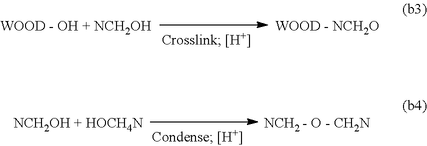

### Formula 3: After Xie, Krause & Millitz (2008, p. 358)

Commercially DMDHEU treated wood products, marketed under brand names such as Belmadur and Fixapret (Archroma), have this far had limited success. In the textile industry, it is widely used.

In one aspect of embodiments of the present invention, a method of a liquid phase DMDHEU Wood Modification is provided, wherein the liquid phase DMDHEU Wood Modification comprises the following steps:
a) Selecting the wood to be modified and placing the wood in a suitable impregnation and/or treatment chamber, such as a high pressure/high temperature autoclave;
b) Preparing an impregnation solution comprising DMDHEU, by mixing DMDHEU alcohol in water, creating a pH neutral aqueous impregnation solution. The aqueous impregnation solution may contain from 5% to full saturation, depending on the wood species and the intended end use of the product;
c) Impregnating the wood to be modified with the pH neutral aqueous DMDHEU impregnation solution, utilizing a standard vacuum/pressure impregnation process, e.g. Lowry or Bethell, to the required penetration and uptake. If the impregnation chamber is a separate chamber from the treatment chamber to be utilized in step d), the process will include the additional step of:
   cc) Removing the wood from the impregnation chamber and place it in a separate treatment chamber, suitable for further modification of the wood, such as a high pressure/high temperature autoclave;
d) Without prior drying of the impregnated wood initiating and facilitating a hybrid thermal hydrolysis and polymerisation/reaction process without prior drying of the impregnated wood by increasing the pressure within the treatment chamber, e.g. by applying inert gas, e.g. Nitrogen, in such a way that pressure is always above the boiling point of water, when the treatment chamber is heated above water's ambivalent boiling point;
e) Increasing the temperature of the treatment chamber, thereby facilitating, by means of increased temperature, the hybrid thermal hydrolysis and polymerisation/reaction processes, until the wood to be modified reaches the desired temperature for thermal hydrolysis as well as polymerisation/curing process (“holding phase temperature”). The holding phase temperature shall be in the range of 120 to 200° C., depending on the wood species, ratio of heartwood to sapwood, wood dimensions as well as the desired end use of the product. In embodiments, the temperature and the pressure parameters must be calibrated in such a way that the level of thermal hydrolysis, necessary for the required catalytic effect from the in situ formation of carboxylic acids by hydrolysis on the DMDHEU chemical reaction process, is obtained. The process of increasing the temperature and pressure of the autoclave or treatment chamber, can be achieved in a simultaneous or iterative process comprising one or more iterative or repetitive steps, performed more or less simultaneously for ensuring that the pressure always stays above the boiling point of water;
f) When the treatment chamber has reached the desired holding phase temperature, maintaining both the applied temperature and pressure for a holding phase, the holding phase being in the range of 30 minutes to 12 hours, again depending on wood species, ratio of heartwood to sapwood, dimensions as well as the desired end use of the product; and
g) When the holding phase is completed, decrease both temperature and pressure within the treatment chamber down to ambient temperature and pressure, after which the process is completed, and the wood can be further processed or put to its intended use.

In another aspect of embodiments of the present invention, a method of a vapor phase DMDHEU Wood Modification is provided, wherein the vapor phase DMDHEU Wood Modification comprises the following steps:
a) Selecting the wood to be modified and placing the wood in a suitable treatment chamber, such as a high pressure/high temperature autoclave;
b) Preparing a pH neutral impregnation solution comprising DMDHEU, by mixing DMDHEU in water, comprising between 20-99% DMDHEU;
c) Impregnating the wood with the pH neutral aqueous DMDHEU impregnant solution in a vapor phase, wherein the impregnation process comprises the following steps:
   Heating the treatment chamber, the wood and the pH neutral aqueous DMDHEU impregnant solution to a suitable temperature;
   Pulling a vacuum in the treatment chamber to vaporize the pH neutral aqueous DMDHEU impregnant solution into vapor phase;
   Circulating inside the treatment chamber the vaporized pH neutral aqueous DMDHEU impregnant solution thereby impregnating the wood,
d) Initiating a hybrid thermal hydrolysis and polymerisation/reaction process by further elevating the pressure in the treatment chamber, in such a way that the pressure is always above the boiling point of water, when the treatment chamber is heated above water's ambivalent boiling point;
e) Heating the treatment chamber, wood and PH neutral impregnant solution comprising DMDHEU, thereby facilitating, by means of increased temperature, the combined processes of chemical reaction of Vapor Phase DMDHEU, as well as thermal hydrolysis of wood hemicelluloses, until the wood to be modified reaches the desired temperature for polymerisation/curing process (“holding phase temperature”). The holding phase temperature shall be in the range of 120 to 200° C., depending on the wood species, ratio of heartwood to sapwood, wood dimensions as well as the desired end use of the product. In embodiments, the temperature and the pressure parameters must be calibrated in such a way that the level of hydrolysis, necessary for the required catalytic effect from the in-situ formation of carboxylic acids by hydrolysis on the DMDHEU chemical reaction process, is obtained. The process of increasing the temperature and pressure of the treatment chamber, can be achieved in a simultaneous or iterative process comprising one or more iterative or repetitive steps, performed more or less simultaneously for ensuring that the pressure always stays above the boiling point of water;
f) When the treatment chamber has reached the desired temperature, maintaining both the applied temperature and pressure for a holding phase, the holding phase being in the range of 30 minutes to 12 hours, again depending on wood species, ratio of heartwood to sapwood, dimensions as well as the desired end use of the product; and
g) When the holding phase is completed, decrease both temperature and pressure within the treatment chamber down to ambient temperature and pressure, after which the process is completed, and the wood can be further processed or put to its intended use.

It should be noted that a person skilled in the art would be able to calibrate the relevant process parameters (e.g. solution strength, temperature, pressure, holding time etc.) in such a way that leaching after EN 84 or similar international quality standard is below 5%. When this is obtained, it can be assumed that correct volumes of DMDHEU are taken up in the wood, and that all the DMDHEU in the wood cells has crosslinked with the wood cell wall and further condensated. When leaching is above 5%, it may be assumed that this is caused by too high uptakes of DMDHEU and/or incomplete chemical reaction, and process parameters should be calibrated accordingly.

As explained previously, use of acidic catalysts and the need for a drying phase, are both major disadvantages associated with known Wood Modification processes. Known commercial processes that utilize DMDHEU or Furfuryl Alcohol for Wood Modification, apply a polymerizable composition comprising the cross-linkable compound (DMDHEU or Furfuryl Alcohol) and an acidic catalyst for catalyzing the crosslinking process and they also all apply a drying step between the impregnation step and the polymerization. The above disclosed embodiments of the present invention, provide a vapor phase DMDHEU or Furfuryl Alcohol

Wood Modification processes and a liquid phase DMDHEU or Furfuryl Alcohol Wood Modification process, utilizing a pH neutral DMDHEU or Furfuryl Alcohol solution and omitting the drying step.

The cross-linkable vapor phase impregnation, disclosed in the above embodiments, is a much simpler and more efficient procedure for bringing the cross-linkable compound (DMDHEU, Furfuryl Alcohol) into the wood cell wall, where efficient cross-linking to reduce accessible OH groups takes place, than previously known DMDHEU or Furfuryl Alcohol Wood Modification processes. Furthermore, the utilization of superheated steam at elevated temperature to cause cross-linking of the cross-linkable compound (DMDHEU, Furfuryl Alcohol) facilitates a simultaneous process of thermal hydrolysis of hemicelluloses, removing additional accessible wood OH groups beyond that of amount of OH group removed by the cross-linking achieved by previously known (DMDHEU, Furfuryl Alcohol and others) Wood Modification processes performed at atmospheric pressure.

### LITERATURE

Acosta, A., Beltrame, R., Missio, A., Amico, S., Delucis, R and Gatto, D. (2022): “Furfurylation as a post-treatment for thermally-treated wood”. Biomass Conversion and Biorefinery, Springer online.
Hill, C. (2006): “Wood Modification-Chemical, Thermal and Other Processes”. Wiley & Sons Ltd., West Sussex.
Jones & Sandberg (2020): “A review of Wood Modification Globally—Updated Findings from COST FP1407. Interdisciplinary Perspectives on the Built Environment.
Rowell, R. (1983): “Chemical modification of wood”; Forest Products Abstracts 6(12), 363-382. Thybring, E. (2013): “Review: The decay resistance of modified wood influenced by moisture exclusion and swelling reduction”. International Biodeterioation & Biodegradation 82:87-95
Thybring, E., Digaitis, R., Nord-Larsen, T., Beck, G. and Fredriksson, M. (2020): “How much water can wood cell walls hold? A triangulation approach to determine the maximum cell wall moisture content”. PLOS One, 15(8): e0238319
Xie, Krause & Millitz (2008): “Modification of Wood with N-Methylol Resins”, in Schultz et al.: “Development of Commercial Wood Preservatives”, Chapter 21. ACS Symposium Series; American Chemical Society: New York.

### EXAMPLES

For validating the efficiency of the process provided by embodiments of the present invention, a series of empirical testing were designed and performed.

Embodiments of the present invention provide a method wherein the polymerization of the monomer reagent will happen when combined with the Pyrolysis process, because the acids produced (RCO₂H) from pyrolysis according to (f) will act as a necessary catalyst for the polymerization of the monomer, according to (g). Remembering the general Formula for embodiments of the invention previously disclosed by Formula 1, presented as expressions (a) and (b) further above, polymerization will not happen without the presence of the acidic catalyst (RCO₂H):

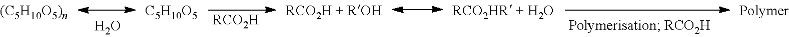

In the following, several tests are reported, with the goal to examine whether polymerization according to (b) of Formula 1., occurs, when impregnated with a pure monomer Furfuryl Alcohol aqueous solution without any added catalyst, that is, a pH neutral aqueous solution of Furfuryl Alcohol. Known conventional art, disclosing chemical modification of wood, including the ones cited previously, require added catalyst in the monomer solution in order for polymerization according to the general expression (b) of Formula 1., and in this case the specific expressions for polymerization of Furfuryl Alcohol according to (b1) and (b2) of Formula 2., to occur.

### Example 1—Empirical Testing of Polymerization

Test 1: Leaching Test The first testing was a leaching test. The purpose of this test is to determine whether the monomer can be leached out of the finished product, indicating that polymerization did not occur. If monomer is not leached out, it can be assumed that polymerization has occurred.

A leaching test according to European Norm EN 84 (1997) was conducted by the Georg-August-Universität, Göttingen, in May 2022. Specimens were modified according to the Wood Modification method provided by embodiments of the present invention. First, specimens of Scots Pine were chosen and placed in a high pressure/high temperature autoclave (step a), a pH neutral 50% aqueous solution of pure Furfuryl Alcohol with no additives (catalysts or other) was prepared by diluting Furfuryl Alcohol in water (step b) and the Scots Pine specimens where then pressure impregnated with the 50% Furfuryl Alcohol solution in liquid phase (step c). a. After the impregnation of step c), the samples were modified by step d) by increasing the pressure to 15 Bar, and step e) by increasing the temperature to 150° C., and then both the increased pressure and temperature were maintained for 2 hours holding time (step f), whereafter both temperature and pressure within the treatment chamber were decreased down to ambient temperature and pressure.

The results from the leaching procedure are summarized in table (1) below.

TABLE 1
Leaching (EN 84, 1997) results of hybrid
hydrolysis and chemical modification

| | | Overall | | |
|---|---|---|---|---|
| | | mass loss | Leached | |
| | | due to | chemicals | WPG_{leached} |
| Treatment | WPG_{no leaching}(%) | EN 84 | (%) | (%) |
| No FA, | −17.3 | 2.98 ± 0.81 | n/a | n/a |
| only | | | | |
| hydrolysis | | | | |
| (reference) | | | | |
| 50% FA | 81.8 | 3.71 ± 0.48 | 8.25 ± 1.07 | 75.05 ± 0.88 |
| hybrid | | | | |
| process | | | | |

The “No FA, only hydrolysis” is a reference, where specimens are only modified thermally by hydrolysis, without having been impregnated with FA (corresponding to (b) of Formula 1., above).

The “overall mass loss due to EN 84” was calculated based on the difference in oven-dry specimens before and after the leaching procedure. It includes both the mass loss due to leaching of impregnated Furfuryl Alcohol as well as leaching of degraded wood cell wall polymers. The latter is a result of the hydrolysis process.

“WPG” is Weight Percentage Gain. The “WPG non-leaching (%)” for the reference, hydrolysis only, specimens, show a mass loss of 17.3%. This is as expected, as it is well described in research how thermal modification of wood causes mechanical degradation and mass loss of the wood cell structure. For the 50% FA specimens, a significant mass increase of 81.8% was recorded, caused by the impregnation and uptake of FA. After leaching, the 50% FA hybrid process specimens still recorded a significant mass increase of 75.05%.

The overall conclusion from the test was that the treatment with 50% Furfuryl Alcohol resulted in high fixation (polymerization) of Furfuryl Alcohol in the wood.

### Example 2—Empirical Testing of Bulking and Cross-Linking

As discussed earlier, the process of Furfurylation is a complex process, where Furfuryl Alcohol is believed to react with itself according to (b1) as well as with cell wall Lignin according to (b2) of Formula 2. These two reactions improve the durability of wood in two different ways; the first by “Bulking”, that is filling the cell wall lumen. This will prevent free water from filling the lumen, causing a decrease in the wood's ability to take up moisture; this leads to increased fungal resistance as well as protection from insects, such as termites.

The second “Cross-Linking” reaction of Furfuryl Alcohol with cell wall Lignin according to (b2) of Formula 2., reduces the amount of accessible OH groups, as discussed previously. This reduction in accessible OH groups also leads to fungal resistance, but not necessarily protection from insects.

To examine the occurrence of the two processes Bulking and Cross-Linking, 3 tests were performed.

### Test 2: Bulking by Insect Resistance

The first test for Bulking, insect resistance, was tested at MPA Eberswalde in June 2022. The applied testing procedure was a 6 week screening test based on EN 117 (2013), determination of the durability against termite attack in a force test.

The specimens were prepared in the same process as the ones reported above in the leaching test 1., of Example 1. Again, No FA Hydrolysis only specimens for reference, as well as 50% FA specimens, were tested. Termites used were Mastotermes Darwiniensis.

Termite survival as well as visual evaluation according to EN 117 were performed, and the results are summarized in table (2) below.

TABLE 2
Extent of destruction of specimens and
mortality of termites - force test

| Test | | | | Visual |
|---|---|---|---|---|
| block | Type of | Surviving termites | | evaluation |
| No. | treatment | Workers (%) | Soldiers (No.) | (EN 117) |
| 1 | 50% FA | 0 | 0 | No attack |
| 2 | hybrid process | 0 | 0 | No attack |
| 5 | No FA | 39 | 0 | Strong attack |
| 6 | hydrolysis only | 72 | 0 | Strong attack |
| K1 | Untreated Pine | 64 | 1 | Strong attack |
| K2 | sapwood | 77 | 0 | Strong attack |

The “No FA hydrolysis only” reference, as well as unmodified pine sapwood, were both strongly attacked by the termites. These results validate the efficacy of the termites as it is well known and expected that both reference subjects are not termite resistant and will be strongly attacked in a force test.

The results also show that the 50% FA hybrid process samples were resistant to termite attack, indicating presence of efficient FA Bulking in the specimens, that demonstrates the high efficiency of the Wood Modification method provided by embodiments of the present invention, and authenticates that the Wood Modification method provided by embodiments of the present invention is achieved by a hybrid modification process in accordance to both the chemical process (b) of Formula 1., and (b1) of Formula 2.

### Test 3: Bulking Efficiency

A second test examining efficiency of Bulking was performed at the Department of Geosciences and Natural Resource Management, University of Copenhagen in October 2021.

From the same test sample as the specimens reported above, test 1, and test 2., the saturated moisture content was calculated for the No FA hydrolysis only, specimens, as well as for the 50% FA hybrid process. Specimens are submerged into water until their weight stabilizes, indicating they are saturated and do not absorb further water. The moisture content is then calculated based on their dry weight and the difference between dry and water saturated weight, so that moisture content is expressed as the ratio of weight of water to dry mass (g/g).

Bulking, i.e. the filling of polymerized FA in the cell wall lumen, should reduce free water uptake in the wood.

The saturated moisture content of the 50% FA hybrid process specimens was calculated to 0.75 g pr. 1 g of dry matter (0.75 g/g), while the No FA hydrolysis only specimens were 1.8 g pr. 1 g of dry matter. This led to the conclusion that the FA hybrid process specimens had dramatically lower moisture content than the reference No FA hydrolysis only specimens. This indicates that significant amount of furfurilation (according to (b1) of Formula 2.) taking place within the cell lumina, thereby hindering the uptake of water.

Thus the Saturated Moisture Content test, as well as the Termite test, both demonstrate that employing the combined thermal hydrolysis and polymerization process provided by embodiments of the present invention, does result in polymerization of the monomer, because the acids produced (RCO₂H) from thermal hydrolysis according to (a) of Formula 1., will act as a necessary catalyst for the polymerization of the monomer, according to (b) of Formula 1., when impregnated with a pure pH neutral aqueous solution comprising the monomer without any added acidic catalysts.

### Test 4: Estimation of Cell Wall Moisture

In a third test, using Low-field Nuclear Magnetic Resonance (LFNMR) relaxometry, the cell wall moisture content was estimated.

This test does not relate to the lumen which is filled by Bulking according to (b1) of Formula 2., but to the cross linking of FA with cell wall Lignin, according to (b2) of Formula 2. Both processes require the presence of an acidic catalyst (H⁺). The cross linking reduces cell wall ability to attract and bind water, causing a decrease in cell wall moisture content. To examine whether a reduction in cell wall moisture could be determined, LFNMR relaxometry (see Thybring et al. 2020) were used to determine the cell water content of the same specimens as utilized in previous tests 1-3.

Natural, non-modified Pine sapwood has a cell wall moisture content of 30-35 g/g.

For the No FA hydrolysis only specimens, the cell wall moisture content was estimated to 11 g/g, showing a significant decrease from non-modified Pine caused by the hydrolysis. It is well established that thermal hydrolysis modification reduces cell wall moisture content, and the result here confirms this established relationship.

For the 50% FA hybrid process, the cell water moisture content was estimated to 7 g/g. The further moisture content decrease of 4 g/g from 11 g/g to 7 g/g, demonstrates that the employment of the combined hydrolysis and polymerization process provided by embodiments of the present invention results in Furfurylation cross linking according to (b2) of Formula 2., when impregnated with a pH neutral aqueous solution comprising the monomer without any added acidic catalysts.

Since (reduction of) maximum cell moisture content is critical for good resistance to fungal decay, the results from the LFNMR relaxometry validate the synergic effect actualized by employing the combined thermal hydrolysis and polymerization process provided by embodiments of the present invention, when compared to non-hybrid processes such as thermal modification or furfurylation.

By combining, in this case, hydrolysis of the cell wall hemicelluloses with Cross Linking of FA with cell wall Lignin into one (hybrid) modification process, the reduction in maximum cell wall moisture is larger and more efficient, compared to when singular, non-hybrid modification techniques (such as hydrolysis) is used.

### Test 5: Further Estimation of Cell Wall Moisture

This is further validated in an additional test examining cell wall moisture content.

For a series of tests, a large sample totaling 900 Pine sapwood specimens were produced at the Danish Technological Institute in March 2023. They comprised 9 different combinations of the hybrid modification process claimed here.

First, specimens of Scots Pine were chosen and placed in a high pressure/high temperature autoclave (step a), a pH neutral 50% aqueous solution of pure Furfuryl Alcohol with no additives (catalysts or other) was prepared by diluting Furfuryl Alcohol in water (step b) and the Scots Pine specimens where then pressure impregnated with the 50% Furfuryl Alcohol solution in liquid phase (step c). a. After the impregnation of step c), the samples were modified by step d) by increasing the pressure to 15 Bar, and step e) by increasing the temperature to 150° C., and then both the increased pressure and temperature were maintained for 2 hours holding time (step f), whereafter both temperature and pressure within the treatment chamber were decreased down to ambient temperature and pressure (step g).

A smaller number of these specimens were then subjected to a 24-hour water vapor uptake test at the Georg-August-Universität, Göttingen. The specimens are subjected to a fully saturated water vapor atmosphere (Relative Humidity=100%) in 24 Hours, and water vapor uptake determined. Since there is no free water present which can fill the lumen, this test-like the LFNMR reported above-determines wood cell moisture content, as its capacity to attract and bind water molecules by means of accessible OH groups in the cell wall.

As already discussed, the amount of accessible OH groups are reduced by both hydrolysis (by decomposition of cell wall hemicelluloses) as well as Cross-Linking of FA to Lignin in the cell wall. Here the aim is to validate synergetic effects on cell wall moisture reduction from hybrid combinations of the two modification techniques reduces, as compared to their individual effects on cell wall water capacity reduction.

The results are summarized below in table 3.

TABLE 3

| | Thermal hydrolysis modification | | | |
|---|---|---|---|---|
| | intensity (° C.) | | | |
| | None | 130° C. | 150° C. | 180° C. |
| | Moisture content after 24 hours at | | | |
| Treatment type | 100% Relative Humidity (%) | | | |
| Untreated Pine sapwood | 17.0% | — | — | — |
| (control) | | | | |
| No FA Hydrolysis only | — | 13.0% | 10.5% | 10.5% |
| 20% FA | — | 7.5% | 8.5% | 9.5% |
| 40% FA | — | 4.9% | 5.1% | 6.5% |
| 60% FA | — | 3.0% | 6.5% | 4% |

“Untreated Pine sapwood (control)” reports the water vapor uptake (in % of dry matter weight) of the reference natural non-treated Pine sapwood after exposure to a saturated moisture content atmosphere (100% Relative humidity, RH) for 24 hours.

The “No FA Hydrolysis only” reports the water vapor uptake in samples only thermally modified by thermal hydrolysis. Table 3 presents how reduction of water vapor uptake is a positive function of modification temperature, which is well established in extant literature. The maximum reduction (from 17.0% to 10.5%) is in the 40% range, which complies with existing research. Thybring, in an extensive review of research in decay resistance of modified wood influenced by moisture exclusion, reported estimated threshold conditions for decay for various Wood Modifications; Amongst these, he reported the threshold values for Furfurylation being at 40% and for Thermal modification at 42% (2013, table 2). For Furfurylation to achieve the 40% threshold, a 35% Weight Percentage Gain was necessary. This approximately corresponds to using a 40% FA aqueous solution in table 3.

The remaining rows (20% FA, 40% FA, 60% FA) report the results from 9 combinations of the combined process of thermal hydrolysis and furfurylation as provided by the Wood Modification method provided by embodiments of the present invention. As demonstrated by the results in table 3., the combined process provided by embodiments of the present invention leads to further significant reductions in cell wall moisture, culminating at a maximum reduction in the 80% range (from 17.0% to 3%). This is a significant reduction, well above what has been reported so far for any type of modification process which is at 60% (See Thybring (2013)).

The results reported in Table 3, therefore demonstrate that the combined process of hydrolysis and furfurylation as provided by the Wood Modification method of embodiments of the present invention produces positive synergetic effects on cell wall water capacity reduction, well above and beyond what is known from conventional art employing existing, non-hybrid, individual modification processes such as thermal modification, furfurylation and acetylation.

Important commercial implications from the synergetic effects can also be derived from Table 3 above.

As discussed further above, efficient decay resistance from Wood Modification requires a reduction in wood cell moisture of at least 42% with thermal hydrolysis modification, and 40% with furfurylation. In Table 3 above, for thermal hydrolysis only, this reduction requires a temperature of between 150 and 180 degrees. For furfurylation, also as discussed above, it requires a 40% concentration of Furfuryl Alcohol.

In Table 3, thermal hydrolysis modification at 130° C. leads to a 24% reduction in moisture content from 17% to 13%, which is well below the 40% required for good fungal decay protection. In the same way data from existing research show that using a 20% Furfuryl Alcohol solution will not be enough to achieve the necessary 40% threshold, required for good decay resistance.

But when combining thermal hydrolysis at 130° C. with a 20% FA solution in the hybrid modification process, the resulting reduction is at 56% from 17% to 7.5%. This is significantly above the required 40%, so that the hybrid process produces significant synergetic effects.

The commercial implications from the synergetic effects demonstrated by the Wood Modification method provided by embodiments of the present invention are, amongst others, reduced energy costs, reduced process costs such as monomer consumption, reduced process time and improved product quality as modification can be performed at low temperatures and low uptakes of monomers without use of additives such as acidic catalysts. As the acidic catalysts used in contemporary industrial Wood Modification are considered hazardous products, hybrid modification without such catalysts offers an uncomplicated alternative process with reduced hazard risks for environment and operators.

### Example 3—Durability

The tests reported above focus on the chemical changes and related changes in moisture sorption behavior. Research has established a very strong correlation between such changes and wood performance, especially resistance to decay from fungal attack. A critical commercial quality of modified wood products is its decay resistance, i.e. its ability to withstand fungal attack. Decay resistance, or durability, is evaluated and reported in accordance with relevant norms that describe testing procedures (laboratory, field) and how durability is evaluated and classified.

### Test 6. Durability Performance

To determine durability performance from the hybrid modification process, a large laboratory fungal test was launched in September 2022 at the Danish Technological Institute. The sample from which the specimens were taken is the same as the one utilized in test 5., reported in Table 3 above.

The durability test was performed according to CEN/TS 15083-2 (2005): Durability of wood and wood-based products-Determination of natural durability of solid wood against wood-destroying fungi, test methods-part 2: soft rotting micro-fungi. This test is considered relevant for testing wooden products for in-ground (soil contact) applications, as described for Use Class 4 in EN 335.

Durability performance is evaluated on basis of change in Modulus of Elasticity (MOE), which is a measure of mechanical strength loss in the wood fiber caused by soft rot attack. The smaller the loss in MOE, the better the durability performance.

After 16 weeks, a preliminary evaluation was made of one combination (150° C., 40% FA) hybrid process sample. According to Table 3, this combination had a cell wall moisture reduction of 70%, from 17% to 5.1%. This comparison is relevant, as in-ground applications are considered saturated water vapor environments (100% Relative Humidity).

The preliminary evaluation showed that the untreated control reference had a median MOE loss of 18.7%, based on microscopically confirmed soft rot attack. In other words, the control reference was significantly attacked by soft rot.

In comparison, the Hybrid process sample had a median MOE loss of 0%, which led to the durability class rating “1—very durable” after EN 350 (2016). For the class 1 very durable rating, the norm accepts a loss in MOE of up to 10% after 32 weeks. In other words, the hybrid process sample had no soft rot attack and provided complete protection from soft rot fungal attacks.

This result validates the expected correlation between the superior reduction in cell wall water capacity reduction reported above, and superior durability performance from hybrid Wood Modification process.

In conclusion, a variety of tests from Hybrid modification of wood at elevated pressure were reported above.

The process was characterized by the absence of any catalysts in the pure aqueous solution of Furfuryl Alcohol, but any suitable monomer could be used; without applying any physical or chemical treatment between the impregnation step c) and the modification steps (d-f), such as drying of wood by employing the Wood Modification method provided by embodiments of the present invention, that combines two different modification techniques into one new combined modification technique thereby producing a modified wood with surprisingly superior properties due to the synergistic effects of embodiments of the present invention.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method of modifying wood, wherein the method comprises the steps of:
a) selecting and placing the wood in a treatment chamber;
b) preparing a pH neutral aqueous impregnant solution comprising at least one reagent suitable for polymerization and/or chemical reaction with the wood;
c) impregnating the wood with the pH neutral aqueous impregnant solution;
d) increasing the pressure in the treatment chamber, so that the pressure is above the boiling point of water for any temperature in the treatment chamber, and
e) increasing the temperature in the treatment chamber, so that a combined processes of polymerization/chemical reaction of the impregnant and hydrolysis of wood hemicelluloses is facilitated;
wherein the wood does not receive any physical and or chemical treatment between step c) and step d).

2. The method of modifying wood, according to claim 1, wherein the impregnation of step c) comprises:
heating the treatment chamber, the wood, and the pH neutral aqueous impregnant solution prepared in step b) to a suitable temperature;
pulling a vacuum in the treatment chamber to vaporize the pH neutral aqueous impregnant solutioning prepared in step b) into vapor phase;
circulating inside the treatment chamber the vaporized pH neutral aqueous impregnant solutioning prepared in step b), thereby impregnating the wood with the pH neutral aqueous impregnant solution prepared in step b)
wherein the wood does not receive any physical and/or chemical treatment between step c) and d).

3. The method of modifying wood, according to claim 1, further comprising the following steps:
f) when the treatment chamber has reached a desired temperature of step e), maintaining both the applied temperature and pressure for a holding phase; and
h) when the holding phase is completed, decreasing both temperature and pressure within the treatment chamber down to ambient temperature and pressure,
wherein the wood does not receive any physical and/or chemical treatment between step c) and step d).

4. The method according to claim 1, wherein the treatment chamber for impregnating of the wood is a separate impregnating chamber and wherein the method comprises an additional step of:
cc) relocating the impregnated wood from the impregnating chamber to a treatment chamber, wherein step cc is to be performed after the impregnation of step c) and before application of increased pressure of step d) and wherein the wood does not receive any additional physical and/or chemical treatment during step cc).

5. The method according to claim 1, wherein the pH neutral aqueous impregnant solution prepared in step b) comprises one or more reagent suitable for polymerization and/or chemical reaction with the wood, or one or more reagent suitable for polymerization and/or chemical reaction with the wood diluted in water, without any additional catalyst.

6. The method according to claim 1, wherein reagent suitable for polymerization and/or chemical reaction with the wood, utilized for the preparation of the pH neutral aqueous impregnant solutioning in step b) is selected from the group of DMDHEU, Sorbitol, Glycerol, Furfuryl Alcohol, or Xylitol.

7. The method according to claim 1, wherein the pH neutral aqueous impregnant solution prepared in step b) has a pH between 5 and 9.

8. The method according to claim 1, wherein the steps of applying increased pressure in step d) and applying increased temperature in step e) are performed in an iterative or simultaneous process to maintain the pressure in the treatment chamber above water's boiling point when the temperature is increased.

9. The method according to claim 1, wherein the pressure in the treatment chamber is maintained in the range of 5-15 bar during steps e) and f).

10. The method according to claim 1, wherein the temperature in the treatment chamber is increased to above 130 degrees C. in step e).

11. The method according to claim 1, wherein the temperature in the treatment chamber is maintained in the range of 120-200 degrees C. during step f).

12. The method according to claim 1, wherein the wood is engineered wood.

13. The method according to claim 1, wherein the general chemical process achieved in the wood is:

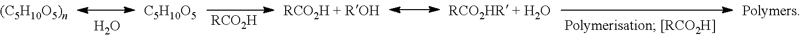

14. Use of the method according to claim 1 for modifying wood.

15. A method for modifying pre-impregnated wood comprising:
a) placing the pre-impregnated wood in a treatment chamber,
b) increasing the pressure in the treatment chamber, so that the pressure is above the boiling point of water for any temperature in the treatment chamber, and
c) increasing the temperature in the treatment chamber, so that a combined process of polymerization/chemical reaction of the impregnant and hydrolysis of wood hemicelluloses is facilitated;
wherein the pre-impregnated wood does not receive any physical and or chemical treatment between step a) and step b).
